(19) United States
(12) Patent Application Publication
(10) Pub. No.: US 2025/0356610 A1
(43) Pub. Date: Nov. 20, 2025

(54) TASK-BASED CAMERA FRAME AUTHENTICATION

(71) Applicant: QUALCOMM Incorporated, San Diego, CA (US)

(72) Inventors: Jonathan PETIT, Wenham, MA (US); Richard Dominic WIETFELDT, San Diego, CA (US); Philip Michael HAWKES, Valley Heights (AU); Jean-Philippe MONTEUUIS, Northborough, MA (US); Cong CHEN, San Diego, CA (US)

(21) Appl. No.: 18/669,181

(22) Filed: May 20, 2024

(51) Int. Cl. G06V 10/25; G06T 7/12; G06T 7/20; G06T 7/50; G06V 10/46

(52) U.S. Cl. CPC G06V 10/25; G06T 7/12; G06T 7/20; G06T 7/50; G06V 10/462; G06V 2201/07

(57) ABSTRACT

Systems and techniques media for image processing are described herein. For example, a device can obtain encryption mode information associated with an image. The encryption mode information includes a region of interest (ROI) of the image and/or a task associated with the image. The device can encrypt at least a portion of image based on the encryption mode information to produce an encrypted image. The device can transmit the encrypted image.

### FIELD

The present disclosure generally relates to image processing. For example, aspects of the present disclosure relate to task-based camera frame authentication.

### BACKGROUND

Increasingly, systems and devices (e.g., autonomous vehicles, such as autonomous and semi-autonomous cars, drones, mobile robots, mobile devices, extended reality (XR) devices, and other suitable systems or devices) include multiple sensors to gather information about the environment, as well as processing systems to process the information gathered, such as for route planning, navigation, collision avoidance, etc. One example of such a system is an Advanced Driver Assistance System (ADAS) for a vehicle. Sensor data, such as images captured from one or more cameras, may be gathered, transformed, and analyzed to detect objects. Securing sensor data, such as image data, for devices is important to ensure data integrity and prevent spoofer attacks, such as in-vehicle attacks.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems and techniques for task-based camera frame authentication. In some aspects, an apparatus for image processing is provided. The apparatus includes a memory (or multiple memories) and a processor (or multiple processors) coupled to the memory and configured to: obtain encryption mode information associated with an image, wherein the encryption mode information includes at least one of a region of interest (ROI) of the image or a task associated with the image; encrypt at least a portion of image based on the encryption mode information to produce an encrypted image; and output the encrypted image for transmission.

In some aspects, a method for image processing is provided. The method includes: obtaining, by a processor of a device, encryption mode information associated with an image, wherein the encryption mode information includes at least one of a region of interest (ROI) of the image or a task associated with the image; encrypting, by the processor, at least a portion of image based on the encryption mode information to produce an encrypted image; and transmitting, by the processor, the encrypted image.

In some aspects, a non-transitory computer-readable medium is provided having stored thereon instructions that, when executed by at least one processor, cause the at least one processor to: obtain encryption mode information associated with an image, wherein the encryption mode information includes at least one of a region of interest (ROI) of the image or a task associated with the image; encrypt at least a portion of image based on the encryption mode information to produce an encrypted image; and output the encrypted image for transmission.

In some aspects, an apparatus for image processing is provided. The apparatus includes: means for obtaining encryption mode information associated with an image, wherein the encryption mode information includes at least one of a region of interest (ROI) of the image or a task associated with the image; means for encrypting at least a portion of image based on the encryption mode information to produce an encrypted image; and means for transmitting the encrypted image

Aspects generally include a method, apparatus, system, computer program product, non-transitory computer-readable medium, user device, user equipment, wireless communication device, and/or processing system as substantially described with reference to and as illustrated by the drawings and specification.

In some aspects, each of the apparatuses described above is, can be part of, or can include a mobile device, a smart or connected device, a camera system, and/or an extended reality (XR) device (e.g., a virtual reality (VR) device, an augmented reality (AR) device, or a mixed reality (MR) device). In some examples, the apparatuses can include or be part of a vehicle, a mobile device (e.g., a mobile telephone or so-called “smart phone” or other mobile device), a wearable device, a personal computer, a laptop computer, a tablet computer, a server computer, a robotics device or system, an aviation system, or other device. In some aspects, the apparatus includes an image sensor (e.g., a camera) or multiple image sensors (e.g., multiple cameras) for capturing one or more images. In some aspects, the apparatus includes one or more displays for displaying one or more images, notifications, and/or other displayable data. In some aspects, the apparatus includes one or more speakers, one or more light-emitting devices, and/or one or more microphones. In some aspects, the apparatuses described above can include one or more sensors. In some cases, the one or more sensors can be used for determining a location of the apparatuses, a state of the apparatuses (e.g., a tracking state, an operating state, a temperature, a humidity level, and/or other state), and/or for other purposes.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

Illustrative aspects of the present application are described in detail below with reference to the following figures:

FIGS. 1A and 1B are block diagrams illustrating a vehicle suitable for implementing various techniques described herein, in accordance with aspects of the present disclosure.

FIG. 1C is a block diagram illustrating components of a vehicle suitable for implementing various techniques described herein, in accordance with aspects of the present disclosure.

FIG. 1D illustrates an example implementation of a system-on-a-chip (SOC), in accordance with some examples.

FIG. 2 is a block diagram illustrating an example architecture of an image capture and processing system, in accordance with some examples.

FIG. 3 is a block diagram illustrating an example of interactions between components of an image capture and processing system, in accordance with some examples.

FIG. 4 is a diagram illustrating an example of a vehicle employing a MIPI system for securing sensor data, in accordance with some examples.

FIG. 5 is a diagram illustrating an example of structure of a CSI-2 packet including an image frame, in accordance with some examples.

FIG. 6 is a diagram illustrating examples of different security variations that may be employed for protection of image data, in accordance with some examples.

FIG. 7 is a diagram illustrating examples of different stride patterns that may be employed for protection of image data, in accordance with some examples.

FIG. 8 is a graph illustrating an example of scalable security for protection of image data, in accordance with some examples.

FIG. 9 is a table illustrating examples of different potential mode switch actions for the scalable security of FIG. 8, in accordance with some examples.

FIG. 10 is a diagram illustrating an example of a process for encrypting portions of an image based on content of the image, in accordance with some examples.

FIG. 11 is a diagram illustrating examples of different types of maps that may be employed for determining one or more regions of interest within an image, in accordance with some examples.

FIG. 12 is a flow diagram illustrating an example of a process for image processing, in accordance with aspects of the present disclosure.

FIG. 13 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As previously mentioned, increasingly, systems and devices (e.g., autonomous vehicles, such as autonomous and semi-autonomous cars, drones, mobile robots, mobile devices, XR devices, and other suitable systems or devices) include multiple sensors (e.g., camera sensors, radar sensors, and/or LIDAR sensors) to gather information about the environment, as well as processing systems to process the information gathered, such as for route planning, navigation, collision avoidance, etc. One example of such a system is an ADAS for a vehicle. Sensor data, such as images captured from one or more cameras, may be gathered, transformed, and analyzed to detect objects.

Securing sensor data (e.g., image sensor data), such when being transferred from an image signal processor (ISP) to an application processor (AP), for devices is important to ensure data integrity and prevent spoofer attacks, such as in-vehicle attacks, which can corrupt the sensor data. Currently, in vehicles, mobile industry processor interface (MIPI) specified source-selective partial integrity and encryption (SSPIE) is often employed to protect the image data (e.g., image frames) from attacks. This solution utilizes message authentication code (MAC), which is generally employed with verification algorithms to verify that a message (e.g., image data) has not been corrupted. These verification algorithms include a key generation algorithm that selects a key from a key space uniformly at random, a signing algorithm that efficiently returns a tag given to the key and the message, and a verifying algorithm that efficiently verifies the authenticity of the message given the same key and the tag.

Currently, MAC has multiple different mode options for the encryption (e.g., MAC mode options including encrypting only the first line of an image, encrypting only a stride pattern of an image, etc.). However, these current MAC modes ignore the content of the image data and, as such, may not secure (e.g., encrypt) the most important portions (e.g., pixels) within the image data.

As such, improved systems and techniques for securing the important portions of image data can be beneficial.

In one or more aspects, systems, apparatuses, processes (also referred to as methods), and computer-readable media (collectively referred to herein as “systems and techniques”) are described herein for providing task-based camera frame authentication. In one or more examples, the systems and techniques add additional MAC modes for encryption of image data that are based on the content of an image such that the most importation portions (e.g., pixels) of the image are encrypted for security.

In some examples, the additional MAC modes can be task-dependent, attention-based, and/or threat-dependent. In one or more examples, the task-dependent MAC modes can identify the important pixels based on a perception task that is using the image data. The attention-based MAC modes can identify the important pixels based on one or more regions of interest within a scene of the image. The threat-dependent MAC modes can identify the important portions (e.g., pixels) of the image based on avoiding possible threats. As such, by employing these additional MAC modes, SSPIE can be used to selectively protect specific image frames or potions thereof.

In one or more aspects, during operation of the systems and techniques for image processing, a first processor (e.g., an ISP) can receive encryption mode information (e.g., MAC mode information) associated with an image. In one or more examples, the encryption mode information can include task-based information identifying at least a portion of the image based on an image processing task, attention-based information identifying at least the portion of the image based on a region of interest of the image, and/or threat-based information identifying at least the portion of the image based on a threat associated with at least the portion of the image. The first processor can encrypt a portion of the image based on the encryption mode information to produce an encrypted image. The first processor can transmit to a second processor (e.g., AP), via a secure connection (e.g., a MIPI), the encrypted image.

In one or more examples, based on the encryption mode information including the task-based information, the first processor can determine at least the portion of the image to encrypt based on performing the image processing task on the image. In some examples, the image processing task can include semantic segmentation, object detection, depth estimation, and/or optical flow.

In some examples, the region of interest can be associated with a class activation map, a saliency map, an attention map generated using an attention network, and/or a depth estimation map. In one or more examples, based on the encryption mode information including the attention-based information, the first processor can determine at least the portion of the image to encrypt based on the region of interest. In some examples, at least the portion of the image can include pixels within the region of interest. In one or more examples, the attention-based information can identify at least the portion of the image based on a plurality of regions of interest of the image. In some examples, at least the portion of the image can include pixels within the plurality of regions of interest.

In one or more examples, the threat-based information can include an attack algorithm applicable to the image. In some examples, the attack algorithm can include at least one of a fast gradient sign algorithm (FGSM) or a projected gradient descent (PGD) algorithm. In one or more examples, based on the encryption mode information including the threat-based information, the first processor can determine at least the portion of the image to encrypt based on performing the attack algorithm on the image.

In some examples, encrypting at least the portion of the image can include applying a MAC to at least the portion of the image. In one or more examples, the first processor (e.g., ISP) can receive the encryption mode information from the second processor (e.g., AP). In some examples, the first processor can be an ISP. In one or more examples, the second processor can be an AP. In some examples, the first processor and the second processor can be within a vehicle. In one or more examples, the secure connection is a MIPI. In some examples, the image can include camera sensor data, radar sensor data, and/or LIDAR sensor data. In some examples, the image can include a set of pixels. In one or more examples, the portion of the image can include a subset of pixels from the set of pixels.

Additional aspects of the present disclosure are described in more detail below.

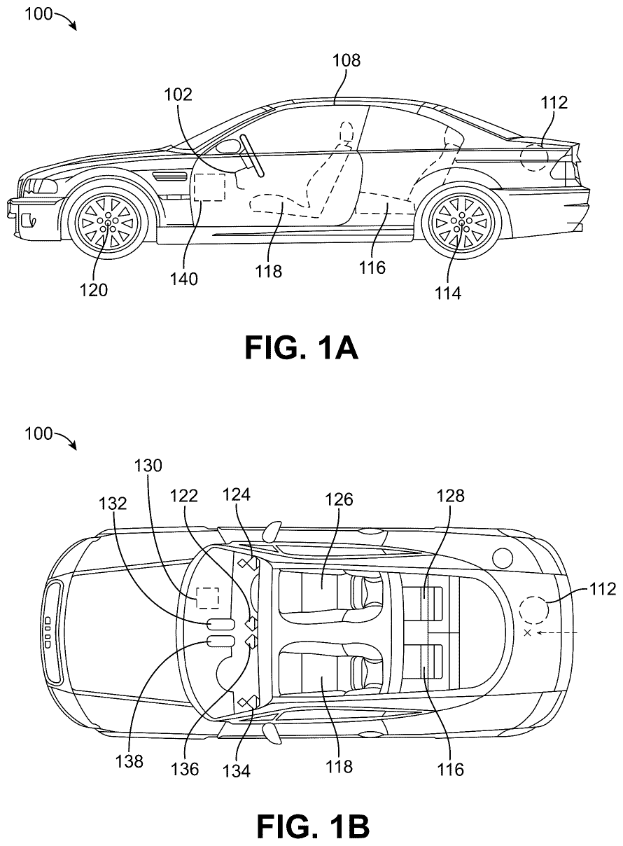

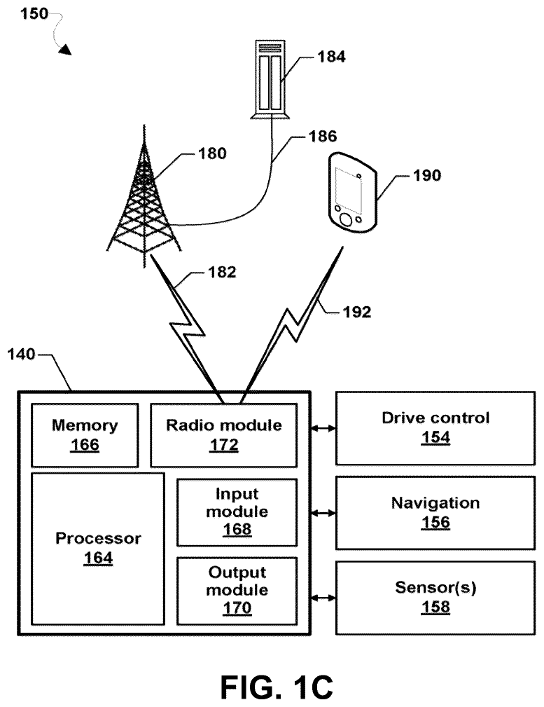

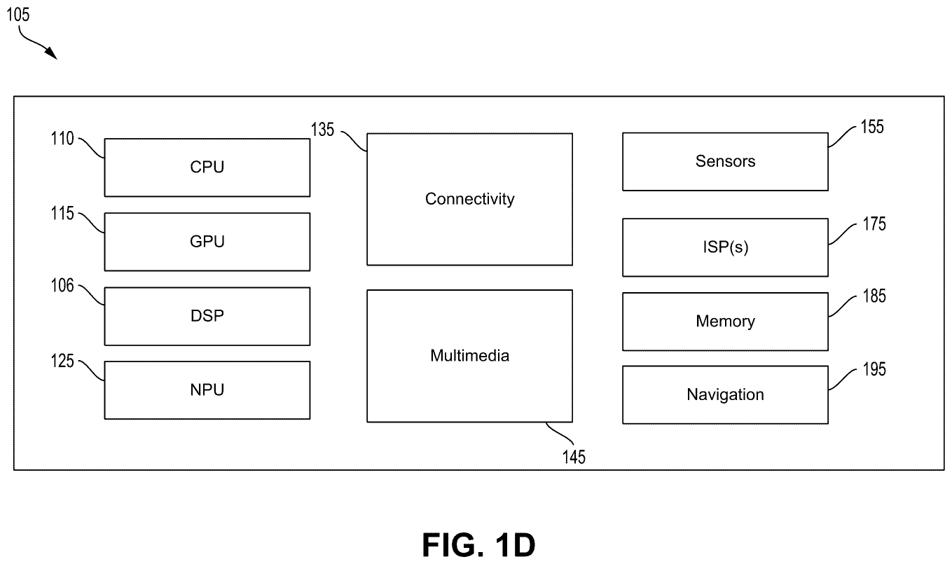

The systems and techniques described herein may be implemented by any type of system or device. One illustrative example of a system that can be used to implement the systems and techniques described herein is a vehicle (e.g., an autonomous or semi-autonomous vehicle) or a system or component (e.g., an ADAS or other system or component) of the vehicle. FIGS. 1A and 1B are diagrams illustrating an example vehicle 100 that may implement the systems and techniques described herein. With reference to FIGS. 1A and 1B, a vehicle 100 may include a control unit 140 and a plurality of sensors 102-138, including satellite geopositioning system receivers (e.g., sensors) 108, occupancy sensors 112, 116, 118, 126, 128, tire pressure sensors 114, 120, cameras 122, 136, microphones 124, 134, impact sensors 130, radar 132, and LIDAR 138. The plurality of sensors 102-138, disposed in or on the vehicle, may be used for various purposes, such as autonomous and semi-autonomous navigation and control, crash avoidance, position determination, etc., as well to provide sensor data regarding objects and people in or on the vehicle 100. The sensors 102-138 may include one or more of a wide variety of sensors capable of detecting a variety of information useful for navigation and collision avoidance. Each of the sensors 102-138 may be in wired or wireless communication with a control unit 140, as well as with each other. In particular, the sensors may include one or more cameras 122, 136 or other optical sensors or photo optic sensors. The sensors may further include other types of object detection and ranging sensors, such as radar 132, LIDAR 138, IR sensors, and ultrasonic sensors. The sensors may further include tire pressure sensors 114, 120, humidity sensors, temperature sensors, satellite geopositioning sensors 108, accelerometers, vibration sensors, gyroscopes, gravimeters, impact sensors 130, force meters, stress meters, strain sensors, fluid sensors, chemical sensors, gas content analyzers, pH sensors, radiation sensors, Geiger counters, neutron detectors, biological material sensors, microphones 124, 134, occupancy sensors 112, 116, 118, 126, 128, proximity sensors, and other sensors.

The vehicle control unit 140 may be configured with processor-executable instructions to perform various embodiments using information received from various sensors, particularly the cameras 122, 136, radar 132, and LIDAR 138. In some embodiments, the control unit 140 may supplement the processing of camera images using distance and relative position information (e.g., relative bearing angle) that may be obtained from radar 132 and/or LIDAR 138 sensors. The control unit 140 may further be configured to control steering, breaking and speed of the vehicle 100 when operating in an autonomous or semi-autonomous mode using information regarding other vehicles determined using various embodiments.

FIG. 1C is a component block diagram illustrating a system 150 of components and support systems suitable for implementing various embodiments. With reference to FIGS. 1A, 1B, and 1C, a vehicle 100 may include a control unit 140, which may include various circuits and devices used to control the operation of the vehicle 100. In the example illustrated in FIG. 1C, the control unit 140 includes a processor 164, memory 166, an input module 168, an output module 170 and a radio module 172. The control unit 140 may be coupled to and configured to control drive control components 154, navigation components 156, and one or more sensors 158 of the vehicle 100.

The control unit 140 may include a processor 164 that may be configured with processor-executable instructions to control maneuvering, navigation, and/or other operations of the vehicle 100, including operations of various embodiments. The processor 164 may be coupled to the memory 166. The control unit 140 may include the input module 168, the output module 170, and the radio module 172.

The radio module 172 may be configured for wireless communication. The radio module 172 may exchange signals 182 (e.g., command signals for controlling maneuvering, signals from navigation facilities, etc.) with a network node 180, and may provide the signals 182 to the processor 164 and/or the navigation components 156. In some embodiments, the radio module 172 may enable the vehicle 100 to communicate with a wireless communication device 190 through a wireless communication link 92. The wireless communication link 92 may be a bidirectional or unidirectional communication link and may use one or more communication protocols.

The input module 168 may receive sensor data from one or more vehicle sensors 158 as well as electronic signals from other components, including the drive control components 154 and the navigation components 156. The output module 170 may be used to communicate with or activate various components of the vehicle 100, including the drive control components 154, the navigation components 156, and the sensor(s) 158.

The control unit 140 may be coupled to the drive control components 154 to control physical elements of the vehicle 100 related to maneuvering and navigation of the vehicle, such as the engine, motors, throttles, steering elements, other control elements, braking or deceleration elements, and the like. The drive control components 154 may also include components that control other devices of the vehicle, including environmental controls (e.g., air conditioning and heating), external and/or interior lighting, interior and/or exterior informational displays (which may include a display screen or other devices to display information), safety devices (e.g., haptic devices, audible alarms, etc.), and other similar devices.

The control unit 140 may be coupled to the navigation components 156 and may receive data from the navigation components 156. The control unit 140 may be configured to use such data to determine the present position and orientation of the vehicle 100, as well as an appropriate course toward a destination. In various embodiments, the navigation components 156 may include or be coupled to a global navigation satellite system (GNSS) receiver system (e.g., one or more Global Positioning System (GPS) receivers) enabling the vehicle 100 to determine its current position using GNSS signals. Alternatively, or in addition, the navigation components 156 may include radio navigation receivers for receiving navigation beacons or other signals from radio nodes, such as Wi-Fi access points, cellular network sites, radio station, remote computing devices, other vehicles, etc. Through control of the drive control components 154, the processor 164 may control the vehicle 100 to navigate and maneuver. The processor 164 and/or the navigation components 156 may be configured to communicate with a server 184 on a network 186 (e.g., the Internet) using wireless signals 182 exchanged over a cellular data network via network node 180 to receive commands to control maneuvering, receive data useful in navigation, provide real-time position reports, and assess other data.

The control unit 140 may be coupled to one or more sensors 158. The sensor(s) 158 may include the sensors 102-138 as described, and may the configured to provide a variety of data to the processor 164.

While the control unit 140 is described as including separate components, in some embodiments some or all of the components (e.g., the processor 164, the memory 166, the input module 168, the output module 170, and the radio module 172) may be integrated in a single device or module, such as a system-on-chip (SOC) processing device. Such an SOC processing device may be configured for use in vehicles and be configured, such as with processor-executable instructions executing in the processor 164, to perform operations of various embodiments when installed into a vehicle.

FIG. 1D illustrates an example implementation of a system-on-a-chip (SOC) 105, which may include a central processing unit (CPU) 110 or a multi-core CPU, configured to perform one or more of the functions described herein. In some cases, the SOC 105 may be based on an ARM instruction set. In some cases, CPU 110 may be similar to processor 164. Parameters or variables (e.g., neural signals and synaptic weights), system parameters associated with a computational device (e.g., neural network with weights), delays, frequency bin information, task information, among other information may be stored in a memory block associated with a neural processing unit (NPU) 125, in a memory block associated with a CPU 110, in a memory block associated with a graphics processing unit (GPU) 115, in a memory block associated with a digital signal processor (DSP) 106, in a memory block 185, and/or may be distributed across multiple blocks. Instructions executed at the CPU 110 may be loaded from a program memory associated with the CPU 110 or may be loaded from a memory block 185.

The SOC 105 may also include additional processing blocks tailored to specific functions, such as a GPU 115, a DSP 106, a connectivity block 135, which may include fifth generation (5G) connectivity, fourth generation long term evolution (4G LTE) connectivity, Wi-Fi connectivity, USB connectivity, Bluetooth connectivity, and the like, and a multimedia processor 145 that may, for example, detect and recognize gestures. In one implementation, the NPU is implemented in the CPU 110, DSP 106, and/or GPU 115. The SOC 105 may also include a sensor processor 155, image signal processors (ISPs) 175, and/or navigation module 195, which may include a global positioning system. In some cases, the navigation module 195 may be similar to navigation components 156 and sensor processor 155 may accept input from, for example, one or more sensors 158. In some cases, the connectivity block 135 may be similar to the radio module 172.

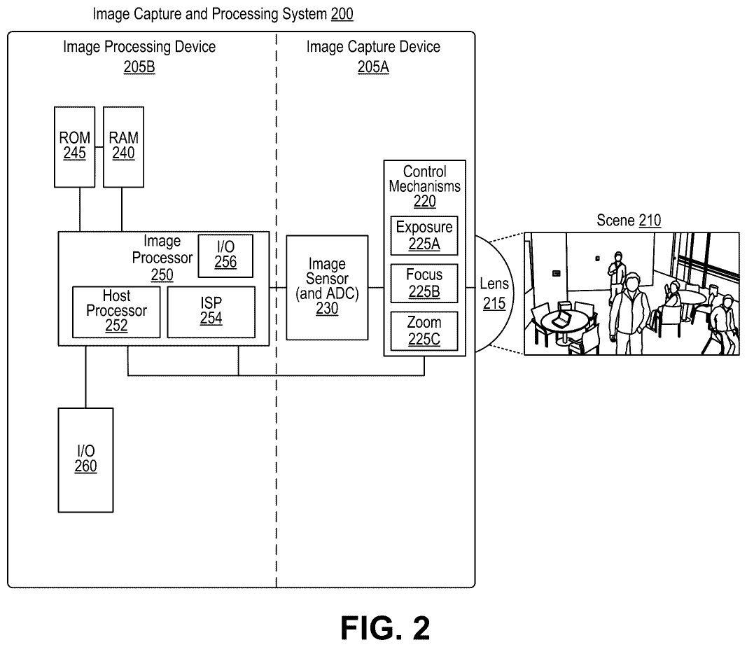

FIG. 2 is a block diagram illustrating an architecture of an image capture and processing system 200. The image capture and processing system 200 includes various components that are used to capture and process images of scenes (e.g., an image of a scene 210). The image capture and processing system 200 can capture standalone images (or photographs) and/or can capture videos that include multiple images (or video frames) in a particular sequence. A lens 215 of the system 200 faces a scene 210 and receives light from the scene 210. The lens 215 bends the light toward the image sensor 230. The light received by the lens 215 passes through an aperture controlled by one or more control mechanisms 220 and is received by an image sensor 230.

The one or more control mechanisms 220 may control exposure, focus, and/or zoom based on information from the image sensor 230 and/or based on information from the image processor 250. The one or more control mechanisms 220 may include multiple mechanisms and components; for instance, the control mechanisms 220 may include one or more exposure control mechanisms 225A, one or more focus control mechanisms 225B, and/or one or more zoom control mechanisms 225C. The one or more control mechanisms 220 may also include additional control mechanisms besides those that are illustrated, such as control mechanisms controlling analog gain, flash, HDR, depth of field, and/or other image capture properties.

The focus control mechanism 225B of the control mechanisms 220 can obtain a focus setting. In some examples, focus control mechanism 225B store the focus setting in a memory register. Based on the focus setting, the focus control mechanism 225B can adjust the position of the lens 215 relative to the position of the image sensor 230. For example, based on the focus setting, the focus control mechanism 225B can move the lens 215 closer to the image sensor 230 or farther from the image sensor 230 by actuating a motor or servo, thereby adjusting focus. In some cases, additional lenses may be included in the system 200, such as one or more microlenses over each photodiode of the image sensor 230, which each bend the light received from the lens 215 toward the corresponding photodiode before the light reaches the photodiode. The focus setting may be determined via contrast detection autofocus (CDAF), phase detection autofocus (PDAF), or some combination thereof. The focus setting may be determined using the control mechanism 220, the image sensor 230, and/or the image processor 250. The focus setting may be referred to as an image capture setting and/or an image processing setting.

The exposure control mechanism 225A of the control mechanisms 220 can obtain an exposure setting. In some cases, the exposure control mechanism 225A stores the exposure setting in a memory register. Based on this exposure setting, the exposure control mechanism 225A can control a size of the aperture (e.g., aperture size or f/stop), a duration of time for which the aperture is open (e.g., exposure time or shutter speed), a sensitivity of the image sensor 230 (e.g., ISO speed or film speed), analog gain applied by the image sensor 230, or any combination thereof. The exposure setting may be referred to as an image capture setting and/or an image processing setting.

The zoom control mechanism 225C of the control mechanisms 220 can obtain a zoom setting. In some examples, the zoom control mechanism 225C stores the zoom setting in a memory register. Based on the zoom setting, the zoom control mechanism 225C can control a focal length of an assembly of lens elements (lens assembly) that includes the lens 215 and one or more additional lenses. For example, the zoom control mechanism 225C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 215 in some cases) that receives the light from the scene 210 first, with the light then passing through an afocal zoom system between the focusing lens (e.g., lens 215) and the image sensor 230 before the light reaches the image sensor 230. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 225C moves one or more of the lenses in the afocal zoom system, such as the negative lens and one or both of the positive lenses.

The image sensor 230 includes one or more arrays of photodiodes or other photosensitive elements. Each photodiode measures an amount of light that eventually corresponds to a particular pixel in the image produced by the image sensor 230. In some cases, different photodiodes may be covered by different color filters, and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 230 may alternately or additionally include opaque and/or reflective masks that block light from reaching certain photodiodes, or portions of certain photodiodes, at certain times and/or from certain angles, which may be used for phase detection autofocus (PDAF). The image sensor 230 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 220 may be included instead or additionally in the image sensor 230. The image sensor 230 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 250 may include one or more processors, such as one or more image signal processors (ISPs) (including ISP 254), one or more host processors (including host processor 252), and/or one or more of any other type of processor 1310 discussed with respect to the computing system 1300. The host processor 252 can be a digital signal processor (DSP) and/or other type of processor. In some implementations, the image processor 250 is a single integrated circuit or chip (e.g., referred to as a system-on-chip or SoC) that includes the host processor 252 and the ISP 254. In some cases, the chip can also include one or more input/output ports (e.g., input/output (I/O) ports 256), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 256 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 252 can communicate with the image sensor 230 using an I2C port, and the ISP 254 can communicate with the image sensor 230 using an MIPI port.

The image processor 250 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 250 may store image frames and/or processed images in random access memory (RAM) 240/1325, read-only memory (ROM) 245/1320, a cache 1312, a memory unit (e.g., system memory 1315), another storage device 1330, or some combination thereof.

Various input/output (I/O) devices 260 may be connected to the image processor 250. The I/O devices 260 can include a display screen, a keyboard, a keypad, a touchscreen, a trackpad, a touch-sensitive surface, a printer, any other output devices 1335, any other input devices 1345, or some combination thereof. In some cases, a caption may be input into the image processing device 205B through a physical keyboard or keypad of the I/O devices 260, or through a virtual keyboard or keypad of a touchscreen of the I/O devices 260. The I/O 260 may include one or more ports, jacks, or other connectors that enable a wired connection between the system 200 and one or more peripheral devices, over which the system 200 may receive data from the one or more peripheral device and/or transmit data to the one or more peripheral devices. The I/O 260 may include one or more wireless transceivers that enable a wireless connection between the system 200 and one or more peripheral devices, over which the system 200 may receive data from the one or more peripheral device and/or transmit data to the one or more peripheral devices. The peripheral devices may include any of the previously-discussed types of I/O devices 260 and may themselves be considered I/O devices 260 once they are coupled to the ports, jacks, wireless transceivers, or other wired and/or wireless connectors.

In some cases, the image capture and processing system 200 may be a single device. In some cases, the image capture and processing system 200 may be two or more separate devices, including an image capture device 205A (e.g., a camera) and an image processing device 205B (e.g., a computing device coupled to the camera). In some implementations, the image capture device 205A and the image processing device 205B may be coupled together, for example via one or more wires, cables, or other electrical connectors, and/or wirelessly via one or more wireless transceivers. In some implementations, the image capture device 205A and the image processing device 205B may be disconnected from one another.

As shown in FIG. 2, a vertical dashed line divides the image capture and processing system 200 of FIG. 2 into two portions that represent the image capture device 205A and the image processing device 205B, respectively. The image capture device 205A includes the lens 215, control mechanisms 220, and the image sensor 230. The image processing device 205B includes the image processor 250 (including the ISP 254 and the host processor 252), the RAM 240, the ROM 245, and the I/O 260. In some cases, certain components illustrated in the image capture device 205A, such as the ISP 254 and/or the host processor 252, may be included in the image capture device 205A.

The image capture and processing system 200 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 200 can include one or more wireless transceivers for wireless communications, such as cellular network communications, 802.11 wi-fi communications, wireless local area network (WLAN) communications, or some combination thereof. In some implementations, the image capture device 205A and the image processing device 205B can be different devices. For instance, the image capture device 205A can include a camera device and the image processing device 205B can include a computing device, such as a mobile handset, a desktop computer, or other computing device.

While the image capture and processing system 200 is shown to include certain components, one of ordinary skill will appreciate that the image capture and processing system 200 can include more components than those shown in FIG. 2. The components of the image capture and processing system 200 can include software, hardware, or one or more combinations of software and hardware. For example, in some implementations, the components of the image capture and processing system 200 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 200.

The host processor 252 can configure the image sensor 230 with new parameter settings (e.g., via an external control interface such as I2C, I3C, SPI, GPIO, and/or other interface). In one illustrative example, the host processor 252 can update exposure settings used by the image sensor 230 based on internal processing results of an exposure control algorithm from past image frames. The host processor 252 can also dynamically configure the parameter settings of the internal pipelines or modules of the ISP 254 to match the settings of one or more input image frames from the image sensor 230 so that the image data is correctly processed by the ISP 254. Processing (or pipeline) blocks or modules of the ISP 254 can include modules for lens (or sensor) noise correction, de-mosaicing, color conversion, correction or enhancement/suppression of image attributes, denoising filters, sharpening filters, among others. Each module of the ISP 254 may include a large number of tunable parameter settings. Additionally, modules may be co-dependent as different modules may affect similar aspects of an image. For example, denoising and texture correction or enhancement may both affect high frequency aspects of an image. As a result, a large number of parameters are used by an ISP to generate a final image from a captured raw image.

In some cases, the image sensor 230 can support dynamic switching between different operational modes that the image sensor 230 supports. Examples of the different operation modes include power off mode, software standby mode, stream on and off mode, among others. For instance, in stream operation mode, the image sensor is fully powered. With the stream operation on, the image sensor starts streaming image data (e.g., on the CSI-2 PHY layer port or interface). With the stream operation off, the image sensor stops streaming image data. In some cases, the host processor 252 can perform a dynamic parameter reconfiguration process that allows the image sensor 230 to support dynamic switching between the different operational modes without going through stream on and off and/or software standby procedures. Dynamic parameter reconfiguration refers to a process performed by the host processor 252 (e.g., an AP or other processor) to configure and update sensor internal register settings on-the-fly (e.g., as the operational modes change) without powering off the image sensor 230 and then powering on or putting the image sensor 230 into a software standby mode. Software standby mode refers to an operational mode of the image sensor 230 where the image sensor 230 is powered on and the camera control interface (CCI) communication is operational, but the image sensor 230 cannot capture and stream image data (e.g., on the CSI bus).

Such dynamic switching can reduce latency of mode switching processing and can improve user experience. Examples of the image sensor 230 dynamically switching between different operational modes include switching between turning high dynamic range (HDR) on and off, switching between a different number of exposures, switching between turning binning on and off (e.g., generating a 12 megapixel (MP) image using a 2×2 Quad Color Filter Array (QCFA) when binning is on and generating a 48 MP image by remosaicing the QCFA to a Bayer color filter array (CFA) when binning is off), among others.

Switching between operational modes (referred to as mode-switching scenarios) is different than changing image capture settings (referred to as non-mode-switching scenarios). For example, modifying image capture settings (e.g., exposure, focus, etc.) can result in a modification of how an image is captured and/or processed by the image sensor 230 and/or the ISP 254 (e.g., resulting in a brighter image, an image with a particular object in focus, etc.). However, if a setting of the image sensor 230 is incorrect or the image sensor 230 and/or ISP 254 are late in applying a setting in a non-mode-switching scenario, the result will be that a captured image is captured and/or processed with slight loss of quality in the processed image (e.g., without the intended settings, such as the image being slightly darker than intended, with an object slightly more out of focus than intended, etc.). However, when switching between operational modes in a mode-switching scenario (e.g., from HDR off to HDR on), applying the incorrect settings can result in a system failure, such as system hang or freeze, which can require a hardware reset of the ISP 254 and/or other components of the image capture and processing system 200. For instance, if the ISP 254 is unaware of the correct settings of an image frame produced by the image sensor 230 and mistakenly applies erroneous settings or parameters on that image frame for internal pipeline processing, the ISP 254 may freeze and require a hardware reset. As a result, instead of outputting an image frame with reduced quality, the image capture and processing system 200 may have to temporarily shut down and restart (e.g., the display screen may show a blank screen while the system 200 resets).

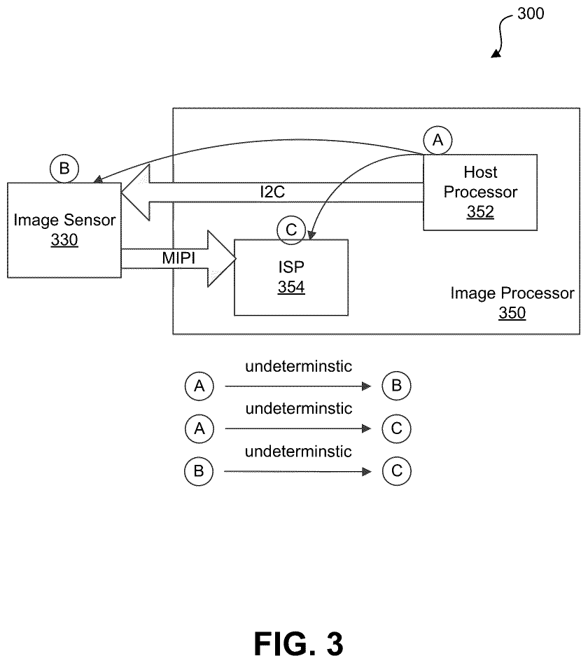

Synchronization between the image sensor 230 and the ISP 254 is important in order to provide an operational image capture system that generates high quality images without interruption and/or failure. FIG. 3 is a block diagram illustrating an example of an image capture and processing system 300 including an image processor 350 (including host processor 352 and ISP 354) in communication with an image sensor 330. The configuration shown in FIG. 3 is illustrative of traditional synchronization techniques used in camera systems. In general, the host processor 352 attempts to provide synchronization between the image sensor 330 and the ISP 354 using fixed periods of time by separately communicating with the image sensor 330 and the ISP 354. For example, in traditional camera systems, the host processor 352 communicates with the image sensor 330 (e.g., over an I2C port) and programs the image sensor 330 parameters with a first fixed period of time, such as 2-frame periods ahead of when that image frame will be processed by the ISP 354. The host processor 352 communicates with the ISP 354 (e.g., over an internal AHB bus or other interface) and programs the ISP 354 parameter settings with a second fixed period of time, such as 1-frame period ahead of when that image frame will be processed by the ISP 354.

The image sensor 330 can send image frames to the ISP 354 (B-to-C in FIG. 3), such as over an MIPI CSI-2 PHY port or interface, or other suitable interface. However, the communication between the host processor 352 and the image sensor 330 (shown as from A to B) is undeterministic. Similarly, the communication between the image sensor 330 and the ISP 354 (shown as from B to C) and the communication the host processor 352 and the ISP 354 (shown as from A to C) are also undeterministic. For example, there can be varying latencies in programming of the image sensor 330 and the ISP 354 by the host processor 352, which can result in a parameter settings mismatch between the sensor and the ISP. The latencies can be due to high CPU usage, congestion in one or more I/O ports, and/or due to other factors.

As previously mentioned, increasingly, systems and devices (e.g., autonomous vehicles, such as autonomous and semi-autonomous cars, drones, mobile robots, mobile devices, XR devices, and other suitable systems or devices) include multiple sensors (e.g., camera sensors, radar sensors, and/or LIDAR sensors) to gather information about the environment, as well as processing systems to process the information gathered, such as for route planning, navigation, collision avoidance, etc. One example of such a system is an ADAS for a vehicle. Sensor data, such as images captured from one or more cameras, may be gathered, transformed, and analyzed to detect objects.

Securing sensor data (e.g., image sensor data), such when being transferred from an ISP to an application processor AP, for devices is important to ensure data integrity and prevent spoofer attacks (e.g., in-vehicle attacks), which can corrupt the sensor data. Currently, MIPI specified SSPIE is often employed in vehicles to protect the image data (e.g., image frames) from attacks. This solution uses MAC, which is generally employed with verification algorithms to verify that a message (e.g., image data) has not been corrupted. These verification algorithms include a key generation algorithm that selects a key from a key space uniformly at random, a signing algorithm that efficiently returns a tag given to the key and the message, and a verifying algorithm that efficiently verifies the authenticity of the message given the same key and the tag.

MIPI specifications (e.g., including camera serial interface 2 (CSI-2), display serial interface 2 (DSI-2), radio frequency front end (RFFE) control interface, and others) are prevalent in vehicles. Original equipment manufacturers and suppliers have adopted them because they are reliable and relatively simple to use. MIPI interfaces are used in vehicles with high-resolution cameras; LIDAR sensors; radar sensors; information, control, and entertainment displays; telematics hubs; audio systems; data storage; and wireless chipsets providing access to cellular, Wi-Fi, Bluetooth, and Global Positioning System (GPS).

MIPI provides a security framework that provides end-to-end security to applications that leverage the MIPI specifications. The framework enables key security functionality, including authentication of system components, data integrity protection, and data encryption. The framework allows for a choice of protocols, cryptographic algorithms, integrity tag modes, and security protection levels. The security framework is uniquely effective in both its security extent and implementation flexibility. The framework allows for securing long-reach wired in-vehicle network connections between MIPI CSI-2-based image sensors and their related processing electronic control units (ECUs). The framework is also applicable to other use cases that leverage MIPI CSI-2-based image sensors for machine vision applications.

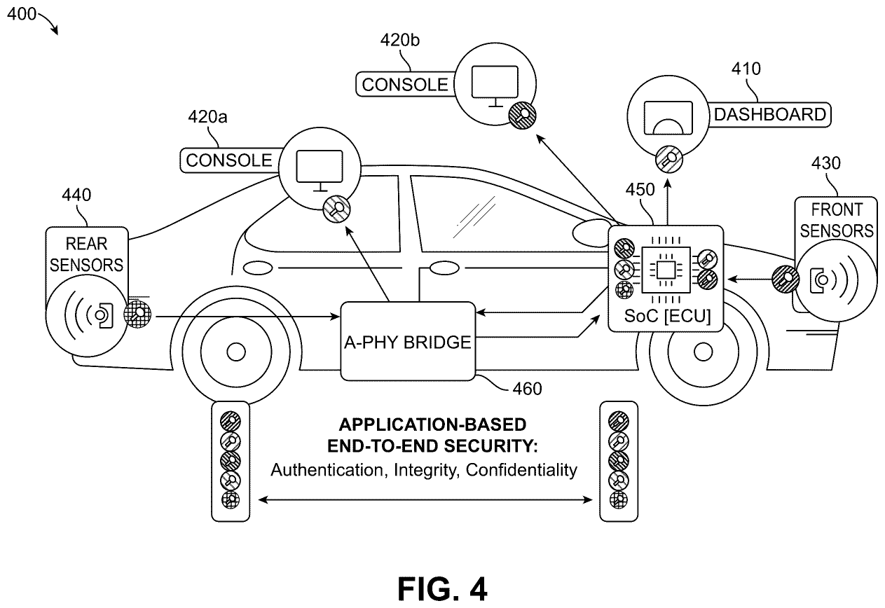

FIG. 4 shows an example of a vehicle with a MIPI system. In particular, FIG. 4 is a diagram illustrating an example of a vehicle 400 employing a MIPI system for securing sensor data (e.g. image data). In FIG. 4, the vehicle 400 is shown to include a dashboard camera 410, a front console camera 420a, a rear console camera 420b, front sensors 430 (e.g., radar and/or LIDAR sensors), and rear sensors 440 (e.g., radar and/or LIDAR sensors). During operation of the vehicle, the dashboard camera 410, front console camera 420a, rear console camera 420b, front sensors 430, and rear sensors 440 can obtain sensor data, and can communicate the sensor data (e.g., via the MIPI system) with a system on a chip (SOC) ECU 450 via an automotive-physical (A-PHY) bridge 460. The MIPI system within the vehicle 400 provides application-based end-to-end security of the data.

The MIPI system allows for mutual trust (e.g., mutual authentication) between the components within the vehicle 400. Once the trust (e.g., authentication) has been established, the MIPI system can provide data integrity (e.g. ensuring the sensor data is unaltered to and/from the ECU 450 provided by MAC) and data confidentiality (e.g., protecting the sensor data against unauthorized access provided by message encryption).

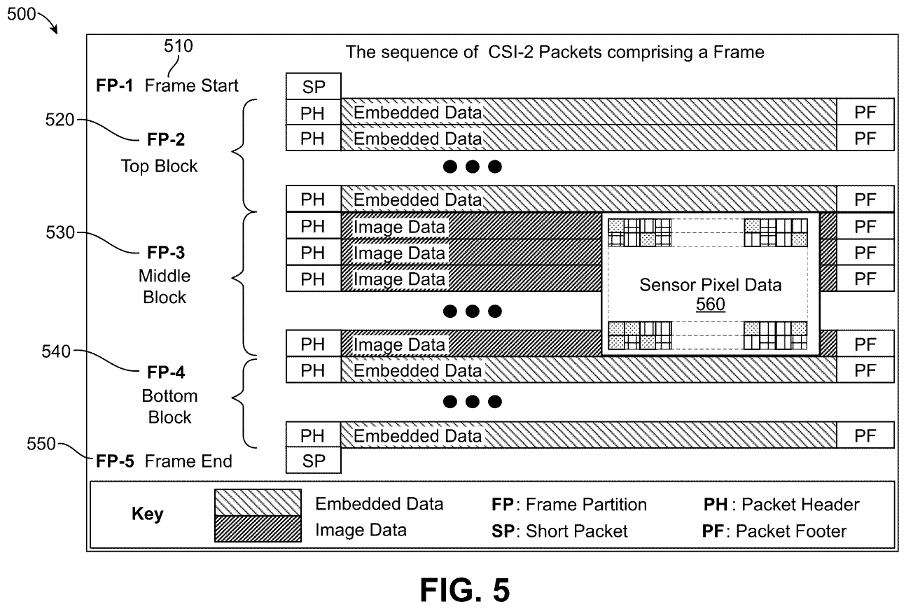

FIG. 5 shows an example of a CSI-2 packet which may be used for sensor data (e.g., image data) within a MIPI system. In particular, FIG. 5 is a diagram illustrating an example of structure of a CSI-2 packet 500 including an image frame. In FIG. 5, the CSI-2 packet 500 is shown to include a frame partition (FP)-1 start 510 that includes a short packet, an FP-2 top block 520 that includes embedded data, an FP-3 middle block 530 that includes image data (e.g., sensor pixel data 560), an FP-4 bottom block 540 that includes embedded data, and an FP-5 frame end 550 that includes a short packet.

In one or more aspects, varying levels of integrity protection (e.g., of sensor data) may be established to meet an objective, such as to implement a reduction in power consumption. These varying levels of protection can relate to cryptographic data protection of image data over wired connections (e.g., MIPI), such as for camera, radar, and/or LIDAR images transmitted to a controller (e.g., ECU 450). Data protection generally refers to data authentication, which includes data integrity (e.g., data or message authentication) and data encryption for confidentiality.

Typically, data integrity protection is an on/off solution, where data integrity protection (e.g., encryption) is applied to all data (e.g., within an image) or not applied to any data (e.g., within the image), This on/off solution does not allow for a separate selection of specific portions of data for encryption for confidentiality.

However, currently, there is a scalable security that allows for “partial integrity” (e.g., only protecting part of the data) and for different security protections for different portions of data (e.g., portions of an image frame). This scalable security allows for reduced power consumption and/or reduced thermal rise in system components that are involved in the cryptographic computations and/or transmissions. These beneficial features are particularly present at the higher camera resolutions and frame rates in some applications.

MIPI refers to this flexible security as SSPIE. This scalable security is source-selective by allowing for different portions (e.g., partitions) of an image frame to have different security requirements and, as such, partial integrity can be achieved where only the selected parts of the payload (e.g., image frame) are integrity protected. As such, encryption can be turned on and off for different portions of an image frame, as necessary.

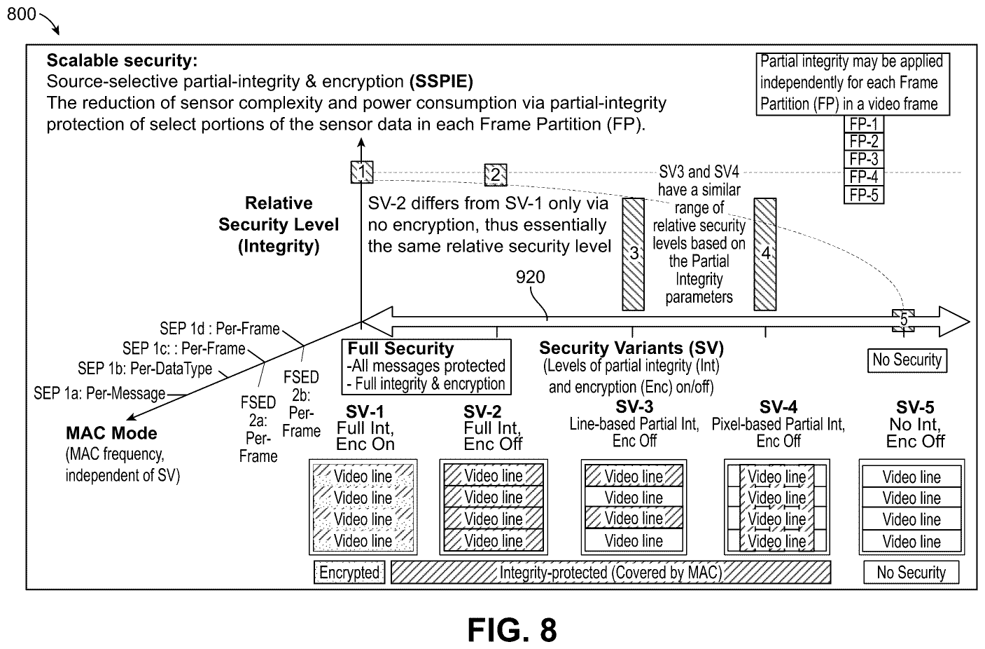

MAC has multiple different mode options for the encryption (e.g., MAC mode options including encrypting only the first line of an image, encrypting only a stride pattern of an image, etc.). Switching options for SSPIE can include selecting the security variant (SV), as shown in the x-axis of the graph 800 of FIG. 8, and selecting the MAC mode, as shown in the y-axis of the graph 800 of FIG. 8.

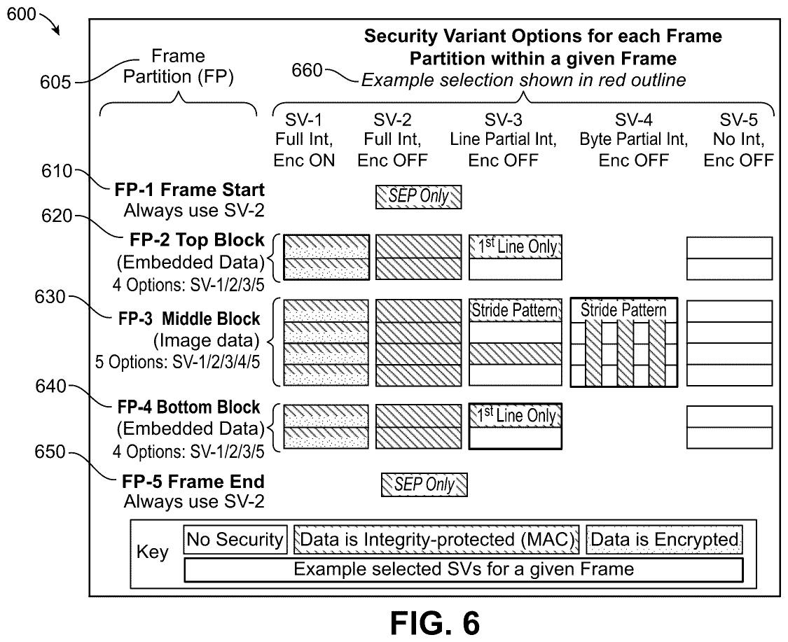

In one or more aspects, partial integrity modes may be identified by various different security variants. FIG. 6 shows examples of different security variants (e.g., SV1, SV2, SV3, SV4, and SV5). In particular, FIG. 6 is a diagram illustrating examples 600 of different security variants that may be employed for protection of image data. In FIG. 6, security variant options 660 for each frame partition (FP) 605 within a given image frame are shown. A different encryption setting (e.g., on or off) may be applied for each frame partition 605.

The different security variants (e.g., SV1, SV2, SV3, SV4, and SV5) can range from a first security variant (SV-1) that provides for full integrity (e.g., full encryption of all image data) to a fifth security variant (SV-5) that provides no encryption of any data. A third security variant (SV-3) and a fourth security variant (SV-4) can provide for encryption of stride patterns of the image data. Different parts of an image frame (e.g., different frame partitions 605) may have different stride patterns.

As shown in FIG. 6, for each frame partition 605 (e.g., FP-1 frame start 610, FP-2 top block 620, FP-3 middle block 630, FP-4 bottom block 640, and FP-5 frame end 650) of a given image frame, a different (and/or a similar) security variant (e.g., SV1, SV2, SV3, SV4, or SV5) may be applied.

In one or more examples, the MAC mode can determine the frequency of computing and transmitting the MAC. Regions of the frame partitions 605 in FIG. 6 are denoted (e.g., as “data is integrity-protected (MAC)”) to indicate partial integrity coverage within the image frame (e.g., to indicate the part of the payload that is included within the MAC calculation and, as such, is protected).

In one or more examples, partial integrity can be parameterized via definition of a stride pattern (SP). In some examples, a stride pattern may be lined based, where selected full lines (e.g., all pixels within a line of an image frame) are included in the MAC. In one or more examples, a stride pattern may be pixel-based, where selected pixels within an image frame line are included in a MAC. In some examples, a stride pattern may be randomized to have a randomized pattern inclusion in a MAC.

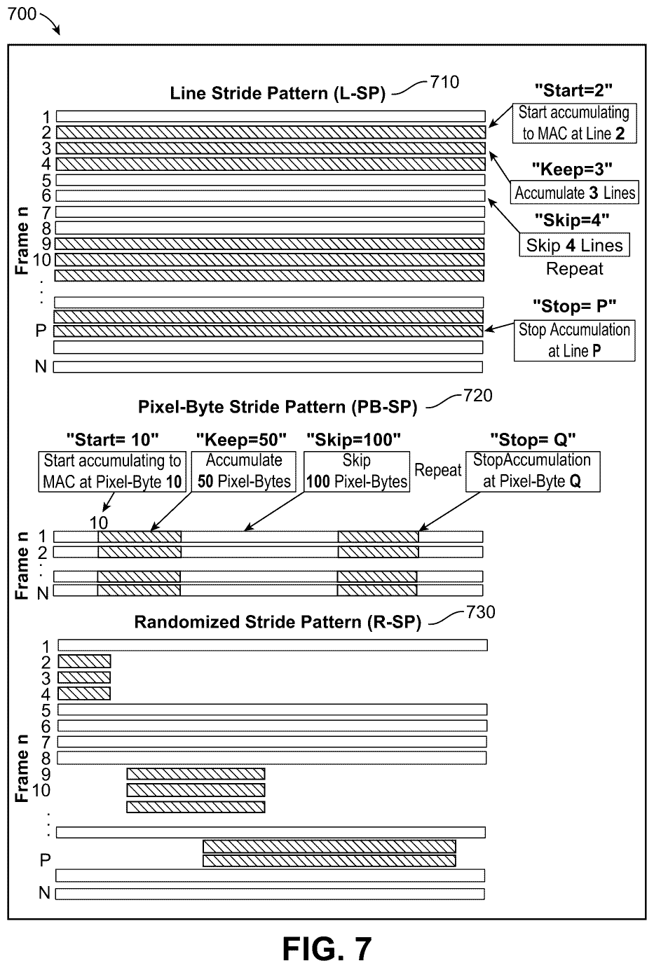

FIG. 7 shows examples of different stride patterns. In particular, FIG. 7 is a diagram illustrating examples 700 of different stride patterns that may be employed for protection of image data. In FIG. 7, an example of a line-based stride pattern (L-SP) 710, a pixel-byte stride pattern (PB-SP) 720, and a randomized stride pattern (R-SP) 730 are shown. The shaded regions within FIG. 7 denote the regions of the image frame that are included in a MAC.

As previously mentioned, the switching options for SSPIE can include selecting the security variant (SV) (e.g., refer to x-axis of FIG. 8) and selecting the MAC mode (e.g., refer to y-axis of FIG. 8). FIG. 8 is a graph 800 illustrating an example of scalable security for protection of image data. The scalable security allows for a reduction of sensor complexity and power consumption via partial-integrity protection of select portions of the sensor data in each frame partition (FP) of an image frame. For the graph 800 of FIG. 8, the x-axis denotes the selection of the security variant (SV), the y-axis denotes the selection of the MAC mode, and the z-axis denotes the relative security (e.g., integrity) level. The selection of the security variant can be based on different potential switch actions 810. In FIG. 8, the graph 800 shows how the different selections of the SV and the MAC mode can vary the amount of relative security (e.g., integrity) level of the image data.

While the MIPI identifies the options for mode switching, the when to switch modes and to which new mode to switch to with what implications are not currently specified and are left to the system implementation. This is a “multi-mode” problem, where the selection of partial integrity SV (and MAC mode) parameters enables tradeoffs between one-time SOC complexity, area, and cost with an operational relative security level, a required crypto-computation limit, a power consumption limit, and a thermal limit. However, this selection allows for a finite probability of attack given that not all of data (e.g., image data) is protected and, as such, must be used carefully.

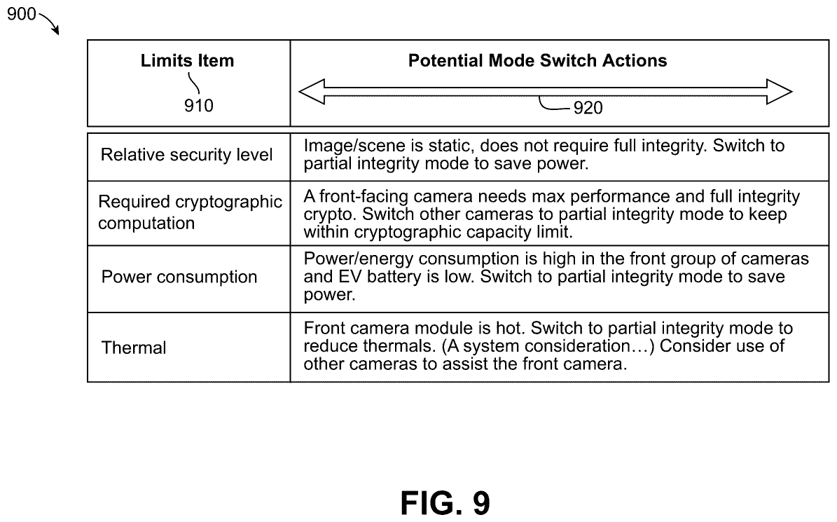

FIG. 9 is a table 900 illustrating examples of different potential mode switch actions 920 for the scalable security of FIG. 8. In FIG. 9, the table 900 is shown to include a limit items 910 column and a potential mode switch actions 920 column. The potential mode switch actions 920 column includes different switching actions that may be chosen for the specific types of limit items (e.g., a relative security level, a required cryptographic computation limit, a power consumption limit, or a thermal limit). For example, relating to a relative security level requirement, when an image or scene is static and does not require full integrity, a partial integrity mode can be switched to in order to save power. For another example, relating to a required cryptographic computation capacity limit, when a front-facing camera need maximum performance and the sensor data needs full integrity cryptography, the other cameras can be switched to partial integrity mode in order to remain within the cryptographic capacity limit. For another example, relating to a power consumption limit, when a power/energy consumption level is high in the front group of cameras and the electric vehicle (EV) battery is low, a partial integrity mode can be switched to in order to conserve power. In yet another example, for a thermal limit, when a front camera module is hot, a partial integrity mode can be switched to in order to reduce the thermal value (e.g., in addition, other cameras may be employed to assist the front camera).

In one or more aspects, during operation for performing a security variant (e.g., partial integrity) mode switch, during start-up of the system, the system can determine the number of cameras within the system; the topology of how the cameras are connected to bridges, aggregators, and/or the SOC within the system; the capabilities of each camera (e.g., the supported image sizes, resolutions, and frame rates), and lookup tables (LUTs) and/or other computations that are associated with analyzing the tradeoff of the relative security level (e.g., refer to z-axis of FIG. 8) versus the switching parameters (e.g., power consumption). Relative security level (RSL) coverage refers to the inclusion of the number of pixels or pixel-messages (e.g., CSI-2 messages) involved in the integrity computations. The RSL coverage can impact the parameters, such as power consumption and thermal savings, over time (e.g., a higher RSL can result in a higher power consumption).

After the start-up of the system, the system can determine the security processing capacity of its controllers and/or SOCs (e.g., 100 Gigabits per second). This capacity may change dynamically, such as based on a power constraint and/or thermal constraint. The system can monitor for any mode change trigger (e.g., which may occur when a power savings is required, a thermal reduction is required, and/or a specific high-value camera scene (or scene fragment) is identified). The system can then determine when a mode change criteria trigger is activated (e.g., a thermal constraint is met on a camera). The system can then determine (e.g., via a LUT and/or computation) the desired partial integrity parameters (e.g., stride pattern parameters) that reduce the integrity computations to meet the goal, which may require turning encryption off. The system can switch into a new partial integrity mode, and can continue to monitor for the occurrence of any new mode change trigger.

In one or more aspects, as previously mentioned, the current MAC modes ignore the content of the image data and, thus, may not secure (e.g., encrypt) the most important portions (e.g., pixels) within the image data. Therefore, improved systems and techniques for securing the important portions of image data can be useful.

In some aspects, the systems and techniques provide task-based camera frame authentication. In one or more examples, the systems and techniques add additional MAC modes for encryption of image data that are based on the content of an image such that the most importation portions (e.g., pixels) of the image are encrypted for security.

In one or more examples, the additional MAC modes may be task-dependent, attention-based, and/or threat-dependent. In some examples, the task-dependent MAC modes may identify the important pixels based on a perception task that is using the image data. The attention-based MAC modes may identify the important pixels based on one or more regions of interest within a scene of the image. The threat-dependent MAC modes may identify the important portions (e.g., pixels) of the image based on avoiding possible threats. Therefore, by employing these additional MAC modes, SSPIE may be used to selectively protect specific image frames or potions thereof.

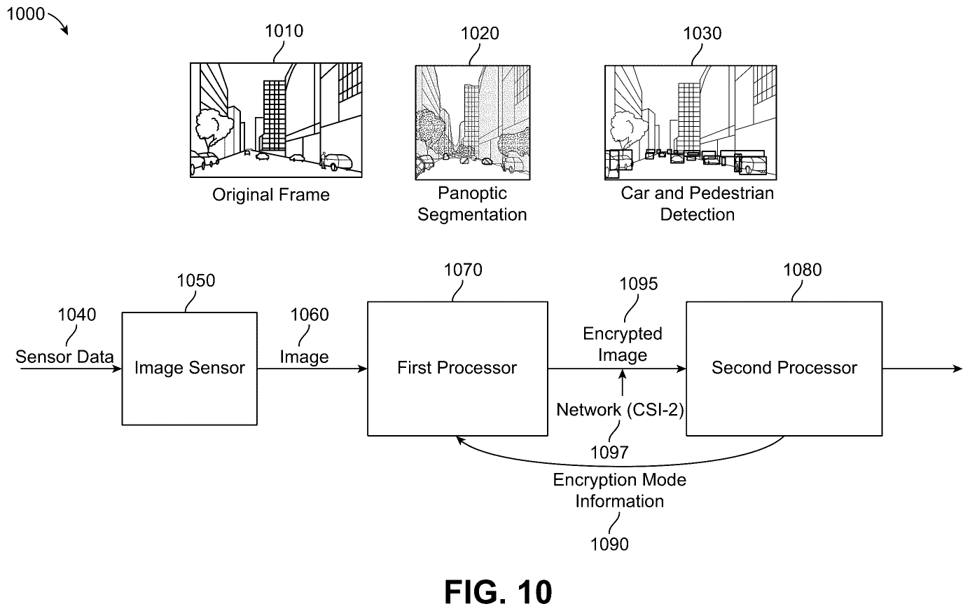

FIG. 10 shows an example process for encrypting portions of an image based on content of the image. In particular, FIG. 10 is a diagram illustrating an example of a process 1000 for encrypting portions of an image 1060 (e.g., an original image frame 1010) based on content of the image 1060. In FIG. 10, an image sensor 1050, a first processor 1070, and a second processor 1080 are shown. In one or more examples, the image sensor 1050 may be a camera sensor, a radar sensor, or a LIDAR sensor. In some examples, the first processor 1070 may be in the form of an ISP, and/or the second processor 1080 may be in the form of an AP. In one or more examples, the image sensor 1050, the first processor 1070, and/or the second processor 1080 may be implemented within the same device (e.g., user equipment or a vehicle).

In one or more examples, during operation of the process 1000 of FIG. 10, the image sensor 1050 (e.g., in the form of a camera sensor) may obtain (e.g., capture) image sensor data 1040 (e.g., camera sensor data, such as light) from a scene. In one or more examples, the image sensor 1050 may be in the form of a camera sensor, a radar sensor, or a LIDAR sensor. The image sensor 1050 can convert the image sensor data 1040 (e.g., light) into a digital value to form the image 1060 (e.g., the original image frame 1010). In some examples, the image 1060 (e.g., the original image frame 1010) may include camera sensor data, radar sensor data, or LIDAR sensor data.

The first processor 1070 (e.g., an ISP) may receive encryption mode information 1090 (e.g., MAC mode information) associated with the image 1060 (e.g., original image frame 1010). In one or more examples, the first processor 1070 (e.g., ISP) may receive the encryption mode information 1090 from the second processor 1080 (e.g., AP). For some of these examples, the second processor 1080 (e.g., AP) may receive an initial image (e.g., with full data integrity, such as by full encryption) from the first processor 1070. The second processor 1080 can then determine, based on the initial image, the encryption mode information 1090 for the first processor 1070 to apply to a predetermined number of images that are obtained subsequent to the initial image. In some examples, the first processor 1070 may receive the encryption mode information 1090 via the network using CSI-2 packet 1097.

In one or more examples, the encryption mode information may include task-based information identifying at least a portion (e.g., pixels) of the image 1060 (e.g., the original image frame 1010) based on an image processing task, attention-based information identifying at least the portion (e.g., pixels) of the image 1060 (e.g., the original image frame 1010) based on a region of interest (ROI) of the image 1060, and/or threat-based information identifying at least the portion (e.g., pixels) of the image 1060 (e.g., the original image frame 1010) based on a threat associated with at least the portion of the image 1060.

In one or more examples, based on the encryption mode information 1090 including the task-based information, the first processor 1070 may determine at least the portion (e.g., pixels) of the image 1060 (e.g., the original image frame 1010) to encrypt based on performing the image processing task on the image 1060. In one or more examples, the first processor 1070 may authenticate regions (e.g., of pixels) that overlap across multiple tasks. In some examples, the image processing task may include semantic segmentation, object detection, depth estimation, and/or optical flow (e.g., indicating movement or no movement within an image).

In FIG. 10, an example of a panoptic segmentation map 1020 obtained by performing (e.g., by the first processor 1070) semantic segmentation on the original image frame 1010 is shown. Also shown in FIG. 10 is an example of an object detection map 1030 (e.g., including bounding boxes for detected cars and pedestrians) obtained by performing (e.g., by the first processor 1070) car and pedestrian object detection on the original image frame 1010.

In one or more examples, the image 1060 (e.g., the original image frame 1010) may include a set of pixels. In some examples, the portion of the image 1060 may include a subset of pixels from the set of pixels. In one or more examples, encrypting at least the portion of the image 1060 (e.g., the original image frame 1010) may include applying a MAC to at least the portion of the image 1060.

In one or more examples, based on the encryption mode information 1090 including the attention-based information, the first processor 1070 may determine at least the portion of the image 1060 (e.g., the original image frame 1010) to encrypt based on the region of interest (ROI). In some examples, at least the portion of the image 1060 (e.g., the original image frame 1010) may include pixels within the region of interest. In one or more examples, the attention-based information may identify at least the portion of the image 1060 (e.g., the original image frame 1010) based on a plurality of regions of interest of the image. In some examples, at least the portion of the image 1060 (e.g., the original image frame 1010) may include pixels within the plurality of regions of interest.

In some examples, the region of interest may be associated with a class activation map (CAM), a saliency map, an attention map generated using an attention network, and/or a depth estimation map. One or more of these maps may be used (e.g., by the first processor 1070 and/or the second processor 1080) to determine the region of interest. In one or more examples, the second processor 1080 and/or the first processor 1070 may generate the class activation map, the saliency map, the attention map generated using an attention network, and/or the depth estimation map.

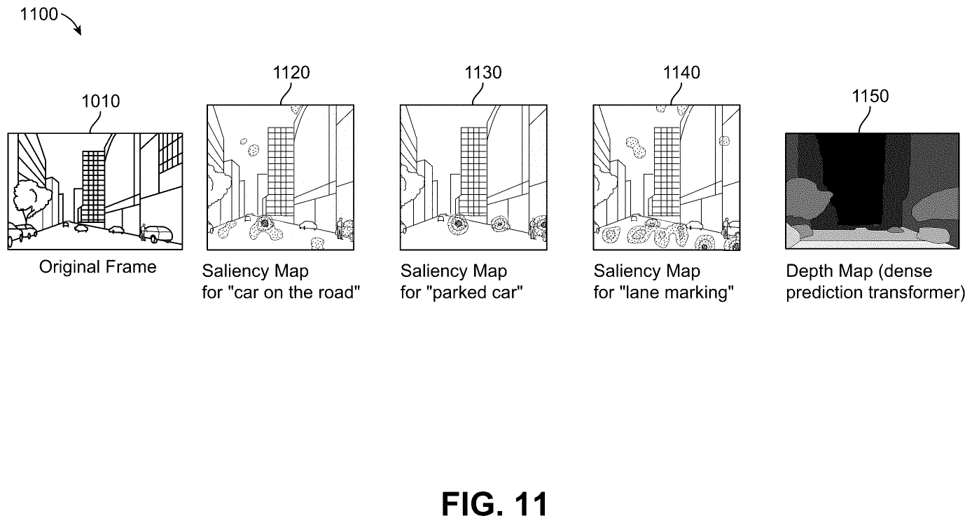

FIG. 11 shows different examples of maps that can be used for determining the regions of interest. In particular, FIG. 11 is a diagram illustrating examples 1100 of different types of maps that may be employed for determining one or more regions of interest within an image (e.g., the original image frame 1010). In FIG. 11, examples of saliency maps 1120, 1130, 1140, and a depth map 1150 are shown.

In FIG. 11, an example of a saliency map for a “car on the road” 1120 obtained (e.g., by the first processor 1070 and/or second processor 1080) from the original image frame 1010 is shown. FIG. 11 also shows an example of a saliency map for a “parked car” 1130 obtained (e.g., by the first processor 1070 and/or second processor 1080) from the original image frame 1010. Also shown in FIG. 11 is an example of a saliency map for “lane marking” 1140 obtained (e.g., by the first processor 1070 and/or second processor 1080) from the original image frame 1010. FIG. 11 additionally shows an example of a depth map 1150 obtained (e.g., by the first processor 1070 and/or second processor 1080, for example by using a dense prediction transformer) from the original image frame 1010.

In one or more examples, an attacker may aim at evading the machine learning-based perception system (e.g., to create misclassification, misdetection, and/or miss detection of objects), and will add adversarial perturbations to specific pixels (e.g., ones with minimal gradient, but with maximal loss) of an image 1060. One MAC mode (e.g., threat-informed) involves running (e.g., by the first processor 1070) an attack algorithm on the image 1060 to highlight the important pixels within the image 1060. These pixels can then be encrypted (e.g., by MAC) to avoid an in-vehicle and/or in-network attacked to manipulate them. As such, in one or more examples, based on the encryption mode information 1090 including the threat-based information, the first processor 1070 may determine at least the portion of the image 1060 (e.g., the original image frame 1010) to encrypt based on performing (e.g., by the first processor 1070) an attack algorithm on the image 1060. In one or more examples, the threat-based information may include the attack algorithm (e.g., a specific attack algorithm) applicable to the image. In some examples, the attack algorithm may include a fast gradient sign algorithm (FGSM) and/or a projected gradient descent (PGD) algorithm.

The first processor 1070 may then encrypt a portion of the image 1060 (e.g., the original image frame 1010) based on the encryption mode information 1090 to produce an encrypted image 1095 (e.g., a MAC image). The first processor 1070 may transmit to the second processor 1080 (e.g., AP), via a secure connection (e.g., a MIPI), the encrypted image 1095.

In one or more examples, the image sensor 1050 may perform some task-specific processing (e.g., analyzing the image frame with object detectors and/or deriving a class activation map from the image frame), and may apply MAC to only the identified pixels and/or regions within the image.

In some examples, the additional MAC modes of the systems and techniques may require that the ISP (e.g., first processor 1070) knows how the image frame (or image frames) will be utilized (e.g., for use cases) and, as such, that the application processor (e.g., the second processor 1080) will need to inform (securely) the ISP beforehand of these uses.

In one or more examples, for a multi-object tracking (MOT) algorithm, where an application processor (e.g., second processor 1080) is interested in “securing” a specific region of an image frame, the application processor may utilize an object detector to detect a first object in a first region of the image frame. To protect the integrity of the multi-object tracking algorithm, the application processor can inform the ISP (e.g., first processor 1070) about the first region and the predicted region(s) (e.g., the MOT algorithm can use a Siamese or Kalman filter to predict where the object might be located within subsequent image frames). The ISP (e.g., first processor 1070) can then secure these regions within the subsequent image frames.

In some examples, the application processor (e.g., second processor 1080) can also prioritize objects based on their safety-relevance. For instance, the ISP (e.g., first processor 1070) may only MAC the targets that are located close by (e.g., determined by depth perception), vulnerable road users (e.g., pedestrians, which may be detected by semantic segmentation), and/or moving towards an ego vehicle (e.g., detected by optical flow)

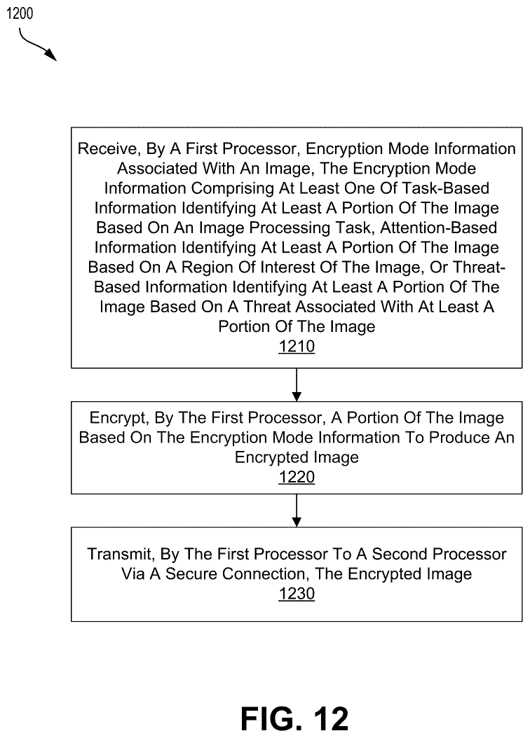

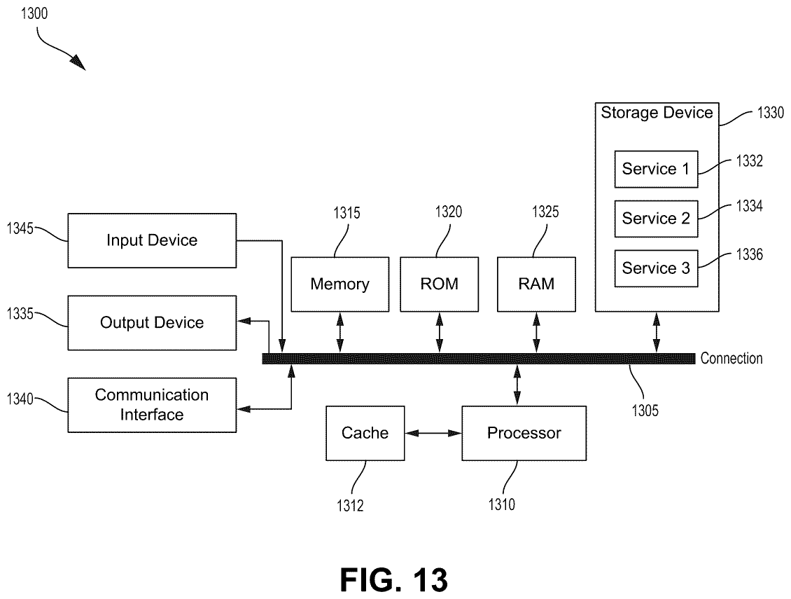

FIG. 12 is a flow chart illustrating an example of a process 1200 for image processing. The process 1200 can be performed by a computing device (e.g., image capture and processing system 200 of FIG. 2, the first processor 1070 of FIG. 10, the second processor 1080 of FIG. 10, a computing device or computing system 1300 of FIG. 13, any combination thereof, and/or device) or by a component or system (e.g., a chipset, one or more processors, such as first processor 1070 of FIG. 10, one or more central processing units (CPUs), digital signal processors (DSPs), graphics processing units (GPUs), any combination thereof, and/or other type of processor(s), or other component or system) of the computing device. In some examples, the computing device is a vehicle or a computing system of the vehicle. The operations of the process 1200 may be implemented as software components that are executed and run on one or more processors (e.g., processor 1310 of FIG. 13 or other processor(s)). Further, the transmission and reception of signals by the computing device in the process 1200 may be enabled, for example, by one or more antennas and/or one or more transceivers (e.g., wireless transceiver(s)).

At block 1210, the computing device (or component thereof, such as the processor 1070 of FIG. 10) can obtain encryption mode information (e.g., encryption mode information 1090 of FIG. 10) associated with an image. The encryption mode information can include a region of interest (ROI) of the image (or information indicating the ROI of the image), a task associated with the image (or information indicating the task associated with the image), any combination thereof, and/or other information.

In some cases, the computing device (or component thereof, such as the processor 1070 of FIG. 10) can obtain (e.g., receive) the image from a camera sensor, a radar sensor, a light detection and ranging (LIDAR) sensor, any combination thereof, and/or from another sensor or source (e.g., a memory, database, etc.).

In some aspects, the computing device (or component thereof, such as the processor 1070 of FIG. 10) can process the image based on an encryption mode associated with the encryption mode information. In some cases, the encryption mode information further includes an identification of the encryption mode. In some examples, to process the image based on the encryption mode, the computing device (or component thereof, such as the processor 1070 of FIG. 10) can determine at least the portion of the image based on the ROI and/or based on the processor performing the task associated with the image. In some cases, the encryption mode is a task-based mode, an attention-based mode, a threat-based mode, any combination thereof, and/or other encryption mode. For instance, the ROI can correspond to the task associated with the image (e.g., identifying the ROI based on performing an image processing task on the image, such as segmentation, as described herein), an attention region (e.g., based on an attention map generated using an attention network, as described herein), a threat (e.g., based on running an attack algorithm on the image to highlight important pixels within the image, as described herein), any combination thereof, etc.

In some cases, the task associated with the image can include semantic segmentation, object detection, depth estimation, optical flow, map generation, attack algorithm performance, any combination thereof, and/or one or more other tasks. For instance, as described herein, to perform the map generation task, the computing device (or component thereof, such as the processor 1070 of FIG. 10) can generate a class activation map, a saliency map, an attention map using an attention network, a depth estimation map, any combination thereof, and/or other map(s). In some cases, as described herein, to perform the attack algorithm task, the computing device (or component thereof, such as the processor 1070 of FIG. 10) can perform a fast gradient sign method (FGSM), a projected gradient descent (PGD) algorithm, any combination thereof, and/or other attack algorithm.

At block 1220, the computing device (or component thereof) can encrypt at least a portion of image based on the encryption mode information to produce an encrypted image (e.g., the encrypted image 1095 of FIG. 10). For instance, the image can include a set of pixels, and at least the portion of the image can include a subset of pixels from the set of pixels. In some cases, to encrypt at least the portion of the image, the computing device (or component thereof) can apply a message authentication code (MAC) to at least the portion of the image.

At block 1230, the computing device (or component thereof) can transmit the encrypted image (or output the encrypted image for transmission). In some aspects, the computing device (or component thereof) can transmit the encrypted image (or output the encrypted image for transmission) to an additional processor of the apparatus, such as via a secure connection (e.g., a mobile industry processor interface (MIPI) or other secure connection). In one illustrative example, the processor is an image signal processor (ISP) of the apparatus (e.g., the first processor 1070 of FIG. 10) and the additional processor is an application processor (AP) of the apparatus (e.g., the second processor 1080 of FIG. 10). In some aspects, the computing device (or component thereof) can obtain (e.g., receive) the encryption mode information from the additional processor.

In some cases, the computing device of process 1200 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 1200 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1200 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1200 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 13 is a block diagram illustrating an example of a computing system 1300, which may be employed for task-based camera frame authentication. In particular, FIG. 13 illustrates an example of computing system 1300, which can be for example any computing device making up internal computing system, a remote computing system, a camera, or any component thereof in which the components of the system are in communication with each other using connection 1305. Connection 1305 can be a physical connection using a bus, or a direct connection into processor 1310, such as in a chipset architecture. Connection 1305 can also be a virtual connection, networked connection, or logical connection.

In some aspects, computing system 1300 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1300 includes at least one processing unit (CPU or processor) 1310 and connection 1305 that communicatively couples various system components including system memory 1315, such as read-only memory (ROM) 1320 and random access memory (RAM) 1325 to processor 1310. Computing system 1300 can include a cache 1312 of high-speed memory connected directly with, in close proximity to, or integrated as part of processor 1310.

Processor 1310 can include any general purpose processor and a hardware service or software service, such as services 1332, 1334, and 1336 stored in storage device 1330, configured to control processor 1310 as well as a special-purpose processor where software instructions are incorporated into the actual processor design. Processor 1310 may essentially be a completely self-contained computing system, containing multiple cores or processors, a bus, memory controller, cache, etc. A multi-core processor may be symmetric or asymmetric.

To enable user interaction, computing system 1300 includes an input device 1345, which can represent any number of input mechanisms, such as a microphone for speech, a touch-sensitive screen for gesture or graphical input, keyboard, mouse, motion input, speech, etc. Computing system 1300 can also include output device 1335, which can be one or more of a number of output mechanisms. In some instances, multimodal systems can enable a user to provide multiple types of input/output to communicate with computing system 1300.

Computing system 1300 can include communications interface 1340, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1340 may also include one or more range sensors (e.g., LiDAR sensors, laser range finders, RF radars, ultrasonic sensors, and infrared (IR) sensors) configured to collect data and provide measurements to processor 1310, whereby processor 1310 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1340 may also include one or more Global Navigation Satellite System (GNSS) receivers or transceivers that are used to determine a location of the computing system 1300 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1330 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1330 can include software services, servers, services, etc., that when the code that defines such software is executed by the processor 1310, it causes the system to perform a function. In some aspects, a hardware service that performs a particular function can include the software component stored in a computer-readable medium in connection with the necessary hardware components, such as processor 1310, connection 1305, output device 1335, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

### Illustrative Aspects of the Disclosure Include:

Aspect 1. An apparatus for image processing, the apparatus comprising: a memory; and a processor coupled to the memory and configured to: obtain encryption mode information associated with an image, wherein the encryption mode information comprises at least one of a region of interest (ROI) of the image or a task associated with the image; encrypt at least a portion of image based on the encryption mode information to produce an encrypted image; and output the encrypted image for transmission.
Aspect 2. The apparatus of Aspect 1, wherein the processor is configured to process the image based on an encryption mode associated with the encryption mode information.
Aspect 3. The apparatus of Aspect 2, wherein, to process the image based on the encryption mode, the processor is configured to determine at least the portion of the image based on at least one of the ROI or the processor performing the task associated with the image.
Aspect 4. The apparatus of any of Aspects 1 to 3, wherein the ROI corresponds to at least one of the task associated with the image, an attention region, or a threat.
Aspect 5. The apparatus of any of Aspects 1 to 4, wherein the task associated with the image comprises at least one of semantic segmentation, object detection, depth estimation, optical flow, map generation, or attack algorithm performance.
Aspect 6. The apparatus of Aspect 5, wherein, to perform the map generation task, the processor is configured to generate of at least one of a class activation map, a saliency map, an attention map using an attention network, or a depth estimation map.
Aspect 7. The apparatus of any of Aspects 5 or 6, wherein, to perform the attack algorithm task, the processor is configured to perform at least one of a fast gradient sign method (FGSM) or a projected gradient descent (PGD) algorithm.
Aspect 8. The apparatus of any of Aspects 1 to 7, wherein, to encrypt at least the portion of the image, the processor is configured to apply a message authentication code (MAC) to at least the portion of the image.
Aspect 9. The apparatus of any of Aspects 1 to 8, wherein the processor is configured to output the encrypted image for transmission to an additional processor of the apparatus.
Aspect 10. The apparatus of Aspect 9, wherein the processor is an image signal processor (ISP) of the apparatus, and wherein the additional processor is an application processor (AP) of the apparatus.
Aspect 11. The apparatus of any of Aspects 9 or 10, wherein the processor is configured to output the encrypted image for transmission to the additional processor via a secure connection.
Aspect 12. The apparatus of Aspect 11, wherein the secure connection is a mobile industry processor interface (MIPI).
Aspect 13. The apparatus of any of Aspects 9 to 12, wherein the processor is configured to obtain the encryption mode information from the additional processor.
Aspect 14. The apparatus of any of Aspects 1 to 13, wherein the apparatus is a vehicle or a computing system of the vehicle.
Aspect 15. The apparatus of any of Aspects 1 to 14, wherein the processor is configured to obtain the image from at least one of a camera sensor, a radar sensor, or a light detection and ranging (LIDAR) sensor.
Aspect 16. The apparatus of any of Aspects 1 to 15, wherein the image comprises a set of pixels, and wherein at least the portion of the image comprises a subset of pixels from the set of pixels.
Aspect 17. The apparatus of any of Aspects 1 to 16, wherein the encryption mode information further comprises an identification of an encryption mode.
Aspect 18. The apparatus of Aspect 17, wherein the encryption mode is at least one of a task-based mode, an attention-based mode, or a threat-based mode.
Aspect 19. A method for image processing, the method comprising: obtaining, by a processor of a device, encryption mode information associated with an image, wherein the encryption mode information comprises at least one of a region of interest (ROI) of the image or a task associated with the image; encrypting, by the processor, at least a portion of image based on the encryption mode information to produce an encrypted image; and transmitting, by the processor, the encrypted image.
Aspect 20. The method of Aspect 19, further comprising processing, by the processor, the image based on an encryption mode associated with the encryption mode information.
Aspect 21. The method of Aspect 20, wherein processing the image based on the encryption mode comprises determining, by the processor, at least the portion of the image based on at least one of the ROI or the processor performing the task associated with the image.
Aspect 22. The method of any of Aspects 19 to 21, wherein the ROI corresponds to at least one of the task associated with the image, an attention region, or a threat.
Aspect 23. The method of any of Aspects 19 to 22, wherein the task associated with the image comprises at least one of semantic segmentation, object detection, depth estimation, optical flow, map generation, or attack algorithm performance.
Aspect 24. The method of Aspect 23, wherein the map generation comprises generating at least one of a class activation map, a saliency map, an attention map using an attention network, or a depth estimation map.
Aspect 25. The method of any of Aspects 23 or 24, wherein the attack algorithm performance comprises performing at least one of a fast gradient sign method (FGSM) or a projected gradient descent (PGD) algorithm.
Aspect 26. The method of Aspect 19, wherein encrypting at least the portion of the image comprises applying a message authentication code (MAC) to at least the portion of the image.
Aspect 27. The method of any of Aspects 19 to 26, wherein the encrypted image is transmitted to an additional processor of the device.
Aspect 28. The method of Aspect 27, wherein the processor is an image signal processor (ISP) of the device, and wherein the additional processor is an application processor (AP) of the device.
Aspect 29. The method of any of Aspects 27 or 28, wherein the encrypted image is transmitted to the additional processor via a secure connection.
Aspect 30. The method of Aspect 29, wherein the secure connection is a mobile industry processor interface (MIPI).
Aspect 31. The method of any of Aspects 27 to 30, further comprising obtaining, by the processor, the encryption mode information from the additional processor.
Aspect 32. The method of any of Aspects 19 to 31, wherein the device is a vehicle or a computing system of the vehicle.
Aspect 33. The method of any of Aspects 19 to 32, further comprising obtaining, by the processor, the image from at least one of a camera sensor, a radar sensor, or a light detection and ranging (LIDAR) sensor.
Aspect 34. The method of any of Aspects 19 to 33, wherein the image comprises a set of pixels, and wherein at least the portion of the image comprises a subset of pixels from the set of pixels.
Aspect 35. The method of any of Aspects 19 to 34, wherein the encryption mode information further comprises an identification of an encryption mode.
Aspect 36. The method of Aspect 35, wherein the encryption mode is at least one of a task-based mode, an attention-based mode, or a threat-based mode.
Aspect 37. A non-transitory computer-readable medium having stored thereon instructions that, when executed by at least one processor, cause the at least one processor to perform operations according to any of Aspects 19 to 36.
Aspect 38. An apparatus for image processing, the apparatus including one or more means for performing operations according to any of Aspects 19 to 36.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for image processing, the apparatus comprising:
a memory; and
a processor coupled to the memory and configured to:
obtain encryption mode information associated with an image, wherein the encryption mode information comprises at least one of a region of interest (ROI) of the image or a task associated with the image;
encrypt at least a portion of image based on the encryption mode information to produce an encrypted image; and
output the encrypted image for transmission.

2. The apparatus of claim 1, wherein the processor is configured to process the image based on an encryption mode associated with the encryption mode information.

3. The apparatus of claim 2, wherein, to process the image based on the encryption mode, the processor is configured to determine at least the portion of the image based on at least one of the ROI or the processor performing the task associated with the image.

4. The apparatus of claim 1, wherein the ROI corresponds to at least one of the task associated with the image, an attention region, or a threat.

5. The apparatus of claim 1, wherein the task associated with the image comprises at least one of semantic segmentation, object detection, depth estimation, optical flow, map generation, or attack algorithm performance.

6. The apparatus of claim 5, wherein, to perform the map generation task, the processor is configured to generate of at least one of a class activation map, a saliency map, an attention map using an attention network, or a depth estimation map.

7. The apparatus of claim 5, wherein, to perform the attack algorithm task, the processor is configured to perform at least one of a fast gradient sign method (FGSM) or a projected gradient descent (PGD) algorithm.

8. The apparatus of claim 1, wherein, to encrypt at least the portion of the image, the processor is configured to apply a message authentication code (MAC) to at least the portion of the image.

9. The apparatus of claim 1, wherein the processor is configured to output the encrypted image for transmission to an additional processor of the apparatus.

10. The apparatus of claim 9, wherein the processor is an image signal processor (ISP) of the apparatus, and wherein the additional processor is an application processor (AP) of the apparatus.

11. The apparatus of claim 9, wherein the processor is configured to output the encrypted image for transmission to the additional processor via a secure connection.

12. The apparatus of claim 11, wherein the secure connection is a mobile industry processor interface (MIPI).

13. The apparatus of claim 9, wherein the processor is configured to obtain the encryption mode information from the additional processor.

14. The apparatus of claim 1, wherein the apparatus is a vehicle or a computing system of the vehicle.

15. The apparatus of claim 1, wherein the processor is configured to obtain the image from at least one of a camera sensor, a radar sensor, or a light detection and ranging (LIDAR) sensor.

16. The apparatus of claim 1, wherein the image comprises a set of pixels, and wherein at least the portion of the image comprises a subset of pixels from the set of pixels.

17. The apparatus of claim 1, wherein the encryption mode information further comprises an identification of an encryption mode.

18. The apparatus of claim 17, wherein the encryption mode is at least one of a task-based mode, an attention-based mode, or a threat-based mode.

19. A method for image processing, the method comprising:
obtaining, by a processor of a device, encryption mode information associated with an image, wherein the encryption mode information comprises at least one of a region of interest (ROI) of the image or a task associated with the image;
encrypting, by the processor, at least a portion of image based on the encryption mode information to produce an encrypted image; and
transmitting, by the processor, the encrypted image.

20. The method of claim 19, further comprising processing, by the processor, the image based on an encryption mode associated with the encryption mode information.
